(19) United States
(12) Patent Application Publication
(10) Pub. No.: US 2026/0214670 A1
(43) Pub. Date: Jul. 23, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Beijing, HaidiannDistrict (CN); Jing Wang, Beijing, HaidiannDistrict (CN); Lan Chen, Beijing, HaidiannDistrict (CN)

(73) Assignee: NTT DOCOMO, INC., Tokyo (JP)

(21) Appl. No.: 19/141,908

(22) PCT Filed: Dec. 23, 2022
(86) PCT No.: PCT/JP2022/047638

§ 371 Date: Jun. 20, 2025

(51) Int. Cl. H04W 72/1273; H04W 64/00; H04W 74/0833

(52) U.S. Cl. CPC H04W 72/1273; H04W 64/00; H04W 74/0833

(57) ABSTRACT

A terminal according to one aspect of the present disclosure includes: a receiving section that receives a first downlink control channel used for a trigger of a random access procedure, a second downlink control channel for scheduling a downlink shared channel for a response signal in the random access procedure, and the downlink shared channel; and a control section that determines, when a case is supported in which the first downlink control channel and the downlink shared channel are transmitted from different cells or different transmission/reception points, quasi-co-location (QCL) assumption in reception of the downlink shared channel, based on at least one of a scenario applied to the random access procedure and configuration information of the transmission/reception points.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, radio communication systems later than Rel. 17/5G), it is assumed to control communication using a plurality of transmission/reception points (for example, a multi-TRP (MTRP) in a serving cell or control communication based on mobility among a plurality of cells (inter-cell mobility) including a non-serving cell.

In this case, it is also assumed to perform certain operation (for example, performing of a random access procedure or configuration of timing advance/timing advance group) for each transmission/reception point or for each serving cell and non-serving cell.

However, how a terminal (a user terminal, a User Equipment (UE)) controls certain operation for a plurality of transmission/reception points (or the serving cell/non-serving cell) poses a problem. Unless certain operation is appropriately controlled, quality of communication using a plurality of transmission/reception points may degrade.

The present disclosure has been made in view of this respect, and has an object to provide a terminal, a radio communication method, and a base station that can appropriately perform communication even when communication is performed using a plurality of transmission/reception points.

### Solution to Problem

A terminal according to one aspect of the present disclosure includes: a receiving section that receives a first downlink control channel used for a trigger of a random access procedure, a second downlink control channel for scheduling a downlink shared channel for a response signal in the random access procedure, and the downlink shared channel; and a control section that determines, when a case is supported in which the first downlink control channel and the downlink shared channel are transmitted from different cells or different transmission/reception points, quasi-co-location (QCL) assumption in reception of the downlink shared channel, based on at least one of a scenario applied to the random access procedure and configuration information of the transmission/reception points.

### Advantageous Effects of Invention

According to one aspect of the present disclosure, even when communication is performed using a plurality of transmission/reception points, communication can be appropriately performed.

### BRIEF DESCRIPTION OF DRAWINGS

FIG. 1A to FIG. 1D are diagrams to show examples of multi-TRPs.

FIG. 2A and FIG. 2B are diagrams to show examples of inter-cell mobility.

FIG. 3A and FIG. 3B are diagrams to show examples of switching between a serving cell and an additional cell by L1/L2 signaling.

FIG. 4 is a diagram to show an example of configuration examples 1 to 3 when candidate cells are supported.

FIG. 5A to FIG. 5C are diagrams to show examples of a case where switching between candidate cells/a candidate cell group by L1/L2 signaling is performed in configuration examples 1 to 3 when candidate cells are supported.

FIG. 6 is a diagram to show an example of timing advance groups (TAGs) to which cells included in a cell group belong.

FIG. 7 is a diagram to show an example of a MAC CE for timing advance command.

FIG. 8A and FIG. 8B are diagrams to show examples of cells/TRPs associated with a PDCCH order and a PDSCH for RAR.

FIG. 9A and FIG. 9B are diagrams to show examples of QCL assumption of a RACH procedure according to a first embodiment.

FIG. 10 is a diagram to show another example of QCL assumption of a RACH procedure according to the first embodiment.

FIG. 11A and FIG. 11B are diagrams to show examples of QCL assumption of a RACH procedure according to a second embodiment.

FIG. 12 is a diagram to show another example of QCL assumption of a RACH procedure according to the second embodiment.

FIG. 13 is a diagram to show an example of a schematic structure of a radio communication system according to one embodiment.

FIG. 14 is a diagram to show an example of a structure of a base station according to one embodiment.

FIG. 15 is a diagram to show an example of a structure of a user terminal according to one embodiment.

FIG. 16 is a diagram to show an example of a hardware structure of the base station and the user terminal according to one embodiment.

FIG. 17 is a diagram to show an example of a vehicle according to one embodiment.

### DESCRIPTION OF EMBODIMENTS

### (TCI, Spatial Relation, QCL)

For NR, control of reception processing (for example, at least one of reception, de-mapping, demodulation, and decoding) and transmission processing (for example, at least one of transmission, mapping, precoding, modulation, and coding) of at least one of a signal and a channel (referred to as a signal/channel) in a UE, based on a transmission configuration indication state (TCI state) has been under study.

The TCI state may be a state applied to a downlink/uplink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:

QCL type A (QCL-A): Doppler shift, Doppler spread, average delay,
and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

Note that a channel/signal being a target of application of a TCI state may be referred to as a target channel/reference signal (RS) or simply as a target, and another signal described above may be referred to as a reference reference signal (reference RS), a source RS, or simply as a reference.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), a reference signal for QCL detection (also referred to as a QRS), a reference signal for demodulation (DeModulation Reference Signal (DMRS)), and the like.

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### (Multi-TRP)

In NR, it is studied that one or a plurality of transmission/reception points (TRPs) (multi-TRP) perform DL transmission to a UE by using one or a plurality of panels (multi-panel). It is also studied that the UE performs UL transmission to the one or plurality of TRPs.

Note that the plurality of TRPs may correspond to the same cell identifier (ID) or may correspond to different cell IDs. The cell ID may be a physical cell ID (for example, a PCI), or may be a virtual cell ID.

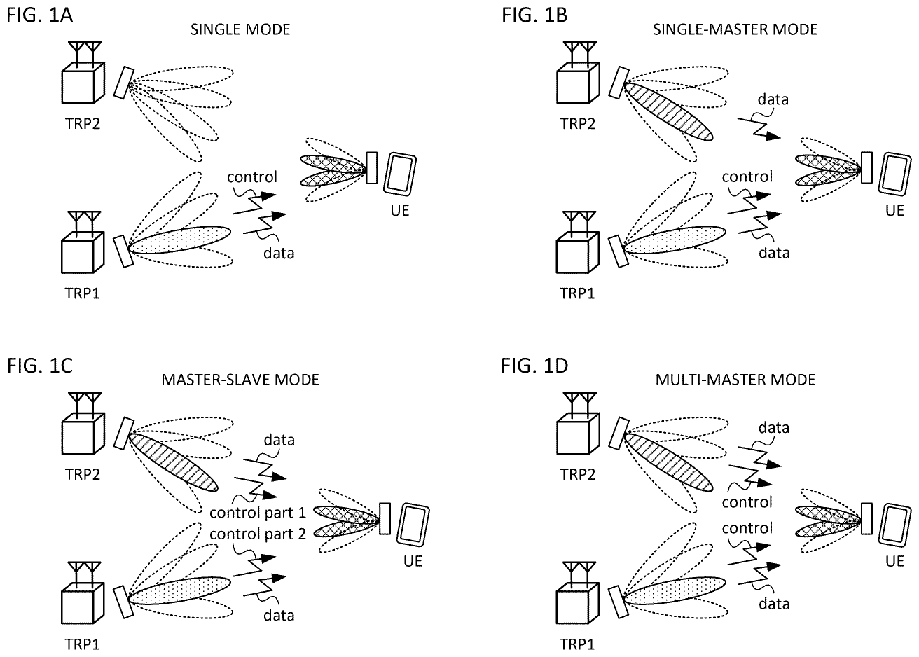

FIGS. 1A to 1D are diagrams to show examples of multi-TRP scenarios. In these examples, it is assumed that each TRP can transmit four different beams; however, this is not restrictive.

FIG. 1A shows an example of a case (which may be referred to as a single mode, a single TRP, or the like) in which only one TRP (in the present example, TRP1) out of the multi-TRP performs transmission to the UE. In this case, TRP1 transmits both of a control signal (PDCCH) and a data signal (PDSCH) to the UE.

In the present disclosure, a single-TRP mode may mean a mode when the multi-TRP (mode) is not configured.

FIG. 1B shows an example of a case (which may be referred to as a single master mode) in which only one TRP (in the present example, TRP1) out of the multi-TRP transmits a control signal to the UE, and the multi-TRP transmits a data signal thereto. The UE receives the PDSCHs transmitted from the multi-TRP, based on a downlink control information (DCI).

FIG. 1C shows an example of a case (which may be referred to as a master slave mode) in which each of the multi-TRP transmits a part of a control signal to the UE, and the multi-TRP transmits a data signal thereto. In TRP1, part 1 of the control signal (DCI) may be transmitted, and in TRP2, part 2 of the control signal (DCI) may be transmitted. Part 2 of the control signal may be dependent upon part 1. The UE receives the PDSCHs transmitted from the multi-TRP, based on these parts of the DCI.

FIG. 1D shows an example of a case (which may be referred to as a multi-master mode) in which each of the multi-TRP transmits a different control signal to the UE, and the multi-TRP transmits a data signal thereto. In TRP1, a first control signal (DCI) may be transmitted, and in TRP2, a second control signal (DCI) may be transmitted. The UE receives the PDSCHs transmitted from the multi-TRP, based on these DCIs.

When a plurality of PDSCHs (which may be referred to as multi-PDSCH (multiple PDSCHs)) from the multi-TRP as shown in FIG. 1B are scheduled using one DCI, the DCI may be referred to as single DCI (S-DCI, single PDCCH). When a plurality of PDSCHs from the multi-TRP as shown in FIG. 1D are respectively scheduled using a plurality of DCIs, the plurality of DCIs may be referred to as multi-DCI (M-DCI, multi-PDCCH (multiple PDCCHs)).

From each TRP of the multi-TRP, different transport blocks (TBs)/codewords (Code Words (CWs))/different layers may be transmitted. Alternatively, from each TRP of the multi-TRP, the same TB/CW/layer may be transmitted.

As one mode of multi-TRP transmission, non-coherent joint transmission (NCJT) has been under study. In NCJT, for example, TRP1 performs modulation mapping and then layer mapping on a first codeword so as to transmit a first PDSCH by using first precoding for a first number of layers (for example, two layers). TRP2 performs modulation mapping and then layer mapping on a second codeword so as to transmit a second PDSCH by using second precoding for a second number of layers (for example, two layers).

Note that it may be defined that a plurality of PDSCHs (multi-PDSCH) to be transmitted using NCJT partially or entirely overlap in at least one of the time and frequency domains. In other words, at least one of the time and frequency resources of the first PDSCH from the first TRP and the second PDSCH from the second TRP may overlap.

It may be assumed that the first PDSCH and the second PDSCH are not in a quasi-co-location (QCL) relationship (not quasi-co-located). Reception of the multi-PDSCH may be interpreted as simultaneous reception of the PDSCHs that are not of a certain QCL type (for example, QCL type D).

In URLLC for the multi-TRP, support of PDSCH (transport block (TB) or codeword (CW)) repetition across the multi-TRP has been under study. Support of repetition schemes across the multi-TRP (URLLC schemes, for example, schemes 1, 2a, 2b, 3, and 4) in the frequency domain, the layer (spatial) domain, or the time domain has been under study. In scheme 1, the multi-PDSCH from the multi-TRP is subjected to space division multiplexing (SDM). In schemes 2a and 2b, the PDSCH from the multi-TRP is subjected to frequency division multiplexing (FDM). In scheme 2a, a redundancy version (RV) is the same for the multi-TRP. In scheme 2b, the RV may be the same or may be different for the multi-TRP. In schemes 3 and 4, the multi-PDSCH from the multi-TRP is subjected to time division multiplexing (TDM). In scheme 3, the multi-PDSCH from the multi-TRP is transmitted in one slot. In scheme 4, the multi-PDSCH from the multi-TRP is transmitted in different slots.

According to the multi-TRP scenario as described above, more flexible transmission control using a channel with satisfactory quality can be performed.

NCJT using multi-TRP/panel may use a high rank. In order to support ideal and non-ideal backhauls among a plurality of TRPs, both of the single DCI (single PDCCH, for example, FIG. 1B) and the multi-DCI (multi-PDCCH, for example, FIG. 1D) may be supported. For both of the single DCI and the multi-DCI, the maximum number of TRPs may be 2.

For single PDCCH design (mainly for the ideal backhaul), enhancement of the TCI has been under study. Each TCI code point in the DCI may correspond to one or two TCI states. A TCI field size may be the same as that of Rel. 15.

Regarding the PDCCH/CORESET defined in Rel. 15, one TCI state without a CORESET pool index (CORESETPoolIndex) (which may be referred to as TRP information (TRP Info)) is configured for one CORESET.

Regarding enhancement of the PDCCH/CORESET defined in Rel. 16, the CORESET pool index is configured for each CORESET in the multi-TRP based on the multi-DCI.

### (Inter-Cell Mobility)

For NR, it is studied that one or a plurality of transmission/reception points (TRPs) (multi-TRP (MTRP)) perform DL transmission to a UE. It is also studied that the UE performs UL transmission to the one or plurality of TRPs.

In Rel. 17 or later versions, it is assumed that L1/L2 inter-cell mobility (for example, L1/L2 inter cell mobility) is supported. In L1/L2 inter-cell mobility, the UE can receive a DL signal/channel from a PCI (or a cell having a different PCI) different from a physical cell ID (for example, a PCI) of the serving cell, and transmit a UL signal/channel to a PCI different from the PCI of the serving cell.

For example, when the non-serving cell has received power (for example, RSRP) greater than the serving cell, the UE may perform reception of a DL signal/channel and transmission of a UL signal/channel with the non-serving cell without performing handover. Switching (dynamic port selection/TRP selection) between the serving cell and the non-serving cell may be performed by DCI/MAC CE (for example, a TCI state indicated by DCI/MAC CE).

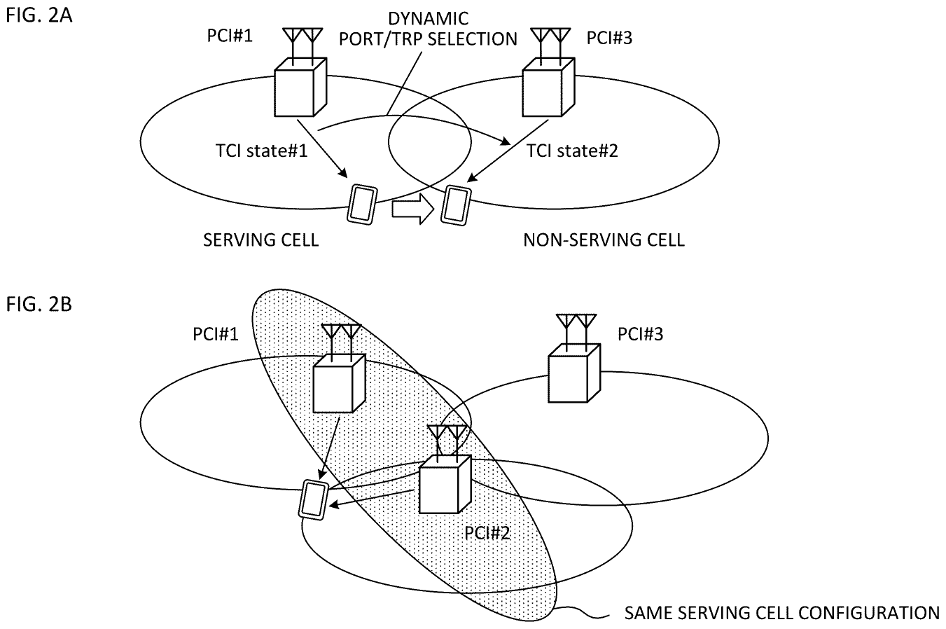

In this manner, it is considered that a UE receives channels/signals from a plurality of cells/TRPs in inter-cell mobility (for example, L1/L2 inter cell mobility) (see FIGS. 2A and 2B).

FIG. 2A shows an example of inter-cell mobility with cells including a non-serving cell (for example, Single-TRP inter-cell mobility). Here, shown is a case of supporting configuration of different physical cell IDs (for example, PCIs) for cell #1 and cell #3. A UE may be configured with one TRP (or a single TRP) in each cell.

FIG. 2A shows a case where the UE receives channels/signals from a base station/TRP of cell #1 (or PCI #1) being a serving cell, and a base station/TRP of cell #3 being not a serving cell (non-serving cell). Here, shown is an example of a case where the UE switches from cell #1 to cell #3 (for example, fast cell switch).

In this case, selection of a port (for example, an antenna port)/TRP or may be performed dynamically. The selection of a port (for example, an antenna port)/TRP or may be performed based on a TCI state indicated or updated by DCI/MAC CE.

FIG. 2B shows an example of a multi-TRP scenario (for example, inter-cell mobility in a case of using multi-TRP (Multi-TRP inter-cell mobility)). A UE may be configured with a plurality of (for example, two) TRPs (or different CORESET pool indices) in each cell. Here, shown is a case where the UE receives channels/signals from TRP #1 and TRP 2. Here, also shown is a case where TRP #1 corresponds to physical cell ID (PCI) #1 and TRP #2 corresponds to PCI #2.

The multi-TRP (for example, TRPs #1 and #2) may be connected via ideal/non-ideal backhaul to exchange information, data, and the like. Each TRP of the multi-TRP may transmit the same or a different codeword (Code Word (CW)) and the same or a different layer. As one mode of multi-TRP transmission, non-coherent joint transmission (NCJT) may be employed as shown in FIG. 2B. Here, shown is a case where NCJT is performed between TRPs corresponding to different PCIs. Note that the same serving cell configuration may be applied/configured for TRP #1 and TRP #2.

It may be defined that a plurality of PDSCHs (multi-PDSCH) subjected to NCJT partially or completely overlap with respect to at least one of time and frequency domains. In other words, a first PDSCH from TRP #1 and a second PDSCH from TRP #2 may overlap in terms of at least one of time and frequency resources. The first PDSCH and the second PDSCH may be used for transmission of the same TB or may be used for transmission of different TBs.

It may be assumed that the first PDSCH and the second PDSCH are not in a quasi-co-location (QCL) relationship (not quasi-co-located). Reception of the multi-PDSCH may be interpreted as simultaneous reception of the PDSCHs that are not of a certain QCL type (for example, QCL type D).

A plurality of PDSCHs (which may be referred to as multi-PDSCH (multiple PDSCHs)) from the multi-TRP may be scheduled by using a DCI (single DCI (S-DCI, single PDCCH)) (single-master mode). The DCI may be transmitted from one TRP of the multi-TRP. A structure using a DCI in multi-TRP may be referred to as single-DCI based multi-TRP (mTRP/MTRP).

The plurality of PDSCHs from the multi-TRP may be scheduled by using DCIs (multi-DCI (M-DCI), multi-PDCCH (multiple PDCCHs)). The DCIs may be transmitted from respective TRPs of the multi-TRP. A structure using DCIs in multi-TRP may be referred to as multi-DCI based multi-TRP (mTRP/MTRP).

The UE may assume to transmit, to the different TRPs, separate CSI reports related to the respective TRPs. Such CSI feedback may be referred to as separate feedback, separate CSI feedback, and the like. In the present disclosure, “separate” may be interchangeably interpreted as “independent.”

In inter-cell mobility, the following scenario 1 or scenario 2 is considered. Note that, in the present disclosure, a serving cell may be interpreted as a TRP in the serving cell. Layer 1/layer 2 (L1/L2) and DCI/Medium Access Control Control Element (MAC CE) may be interchangeably interpreted. In the present disclosure, a physical cell ID (Physical Cell Identity (PCI)) different from the PCI of the current serving cell may be simply referred to as a “different PCI”. A non-serving cell, a cell having a different PCI, and an additional cell may be interchangeably interpreted.

### <Scenario 1>

Scenario 1 corresponds to inter-cell mobility of the multi-TRP, for example. Note that scenario 1 may be a scenario not corresponding to inter-cell mobility of the multi-TRP. In scenario 1, for example, the following procedure is performed.
(1) The UE receives, from the serving cell, a configuration of an SSB for beam measurement of a TRP corresponding to a different PCI from the serving cell and a configuration necessary for using radio resources for data transmission and reception, including resources of the different PCI.
(2) The UE performs beam measurement of the TRP corresponding to the different PCI, and reports beam measurement results to the serving cell.
(3) Based on the above report, the transmission configuration indication (TCI) state associated with the TRP corresponding to the different PCI is activated by L1/L2 signaling from the serving cell.
(4) The UE performs transmission and reception by using a UE-dedicated channel on the TRP corresponding to the different PCI.
(5) The UE needs to invariably cover the serving cell, including a case of the multi-TRP. Similarly to a conventional system, the UE needs to use a common channel (a broadcast control channel (BCCH), a paging channel (PCH)) and the like from the serving cell.

In scenario 1, when the UE transmits and receives an additional cell/TRP (a TRP corresponding to a PCI of the additional cell) and a signal, the serving cell (assumption of the serving cell in the UE) is not changed. In other words, switching of the serving cells by L1/L2 is not supported. The UE is configured with a higher layer parameter related to the PCI of the non-serving cell from the serving cell. Scenario 1 may be applied in Rel. 17, for example.

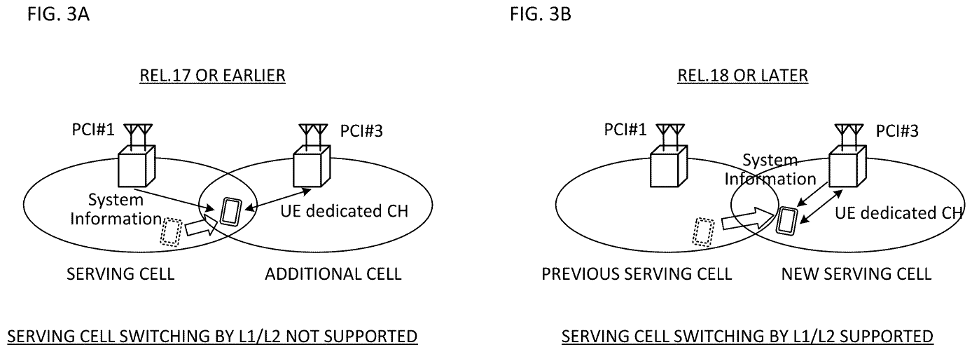

FIG. 3A is a diagram to show an example of movement of the UE in Rel. 17. A case is assumed in which the UE moves from a cell (serving cell) of PCI #1 to a cell (additional cell) (overlapping the serving cell) of PCI #3. In this case, in Rel. 17, switching of the serving cells by L1/L2 is not supported.

The additional cell is a cell having an additional PCI different from the PCI of the serving cell. The UE can receive/transmit a UE-dedicated channel from the additional cell. The UE needs to be present within coverage of the serving cell in order to receive a UE common channel (for example, system information/paging/short message). When the UE moves out of coverage of the serving cell, switching of cells is required through handover (also referred to as L3 mobility) or the like.

### <Scenario 2>

In scenario 2, L1/L2 inter-cell mobility is applied. In L1/L2 inter-cell mobility, the serving cell can be changed by using a function such as beam control without performing RRC reconfiguration. In other words, transmission and reception to and from an additional cell can be performed without performing handover (or without performing an L3 mobility procedure). For handover, RRC reconnection is required, which generates a period in which data communication cannot be performed, and thus by applying L1/L2 inter-cell mobility that does not require handover, data communication can be continued even at the time of the serving cell change. In scenario 2, for example, the following procedure is performed.
(1) The UE receives, from the serving cell, a configuration of an SSB for a cell (additional cell) having a different PCI for beam measurement/serving cell change.
(2) The UE performs beam measurement of the cell using the different PCI, and reports measurement results to the serving cell.
(3) The UE may receive a configuration (serving cell configuration) of the cell having the different PCI by higher layer signaling (for example, RRC). In other words, a pre-configuration related to serving cell change may be performed. The configuration may be performed together with or may be performed separately from the configuration in (1).
(4) Based on the above report, the TCI state of the cell having the different PCI may be activated by L1/L2 signaling according to the serving cell change. The TCI state activation and the serving cell change may be separately performed.
(5) The UE changes the serving cell (assumption of the serving cell), and starts reception/transmission by using a pre-configured UE-dedicated channel and the TCI state.

In other words, in scenario 2, the serving cell (assumption of the serving cell in the UE) is updated by L1/L2 signaling. Scenario 2 may be applied in Rel. 18 or later versions.

FIG. 3B is a diagram to show an example of movement of the UE in Rel. 18. In Rel. 18, the serving cell is switched by L1/L2. The UE can receive/transmit a UE-dedicated channel/common channel from/to a new serving cell. The UE may go out of the coverage of the previous serving cell.

### (Configuration of Candidate Cells)

In L1/L2 inter-cell mobility, in addition to the serving cell, candidate cells may be configured. In the present disclosure, a candidate cell may be interpreted as a target cell, an additional cell, or an additional PCI. One or more candidate cells (or a candidate cell group) may be separately associated with respective serving cells, or one or more candidate cells (or a candidate cell group) may be associated with a plurality of serving cells in common.

Configuration of candidate cells (or a candidate cell group) may be configured similarly to inter-cell beam management (inter-cell BM) of existing systems (for example, Rel. 17 or earlier versions) by using a certain higher layer parameter (for example, ServingCellConfig). Alternatively, for configuration of candidate cells (or a candidate cell group), a framework for carrier aggregation configuration (for example, CA configuration framework) or a framework for CHO (Conditional Handover)/CPC (Conditional PSCell Change) configuration may be reused.

Regarding candidate cells (or a candidate cell group) configured by a higher layer parameter, activation/deactivation may be indicated to the UE by a MAC CE/DCI.

As configuration of candidate cells (or association with serving cells), for example, at least one of the following configuration example 1 to configuration example 3 may be applied. Here, shown is an example of SpCell #0, SCell #1, and SCell #2 being configured as serving cells and candidate cells/a candidate cell group being configured separately from the serving cells. The following configuration example 1 to configuration example 3 are an example, and the number of serving cells/the number of candidate cells/the number of candidate cell groups, association between the serving cells and the candidate cells, and the like are not limited to this and may be changed as appropriate. Alternatively, another configuration example(s) may be supported/employed in addition to/instead of configuration example 1 to configuration example 3.

### Configuration Example 1

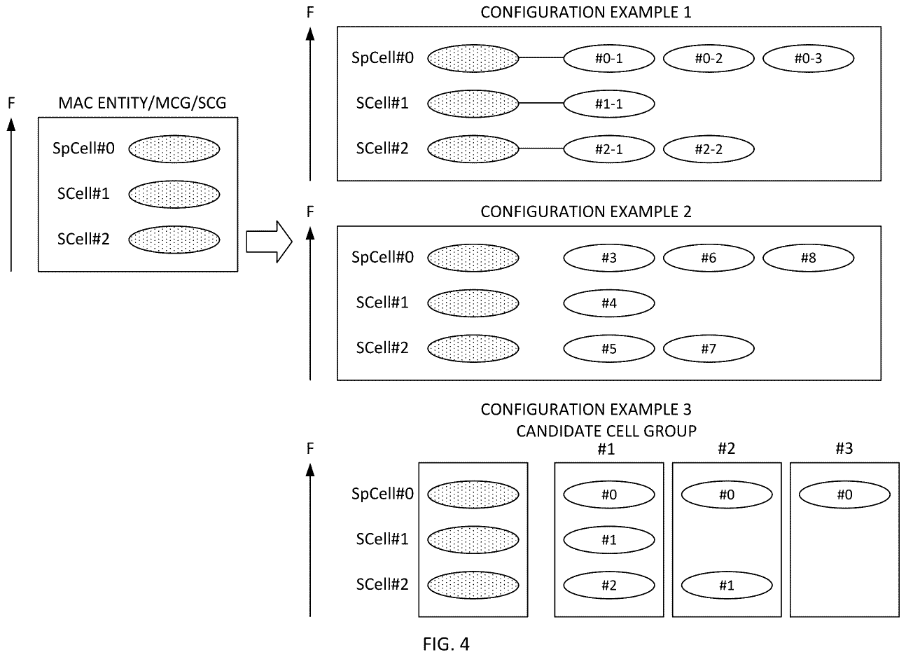

In configuration example 1, one or more candidate cells are respectively associated with/configured for each serving cell (or a frequency domain corresponding to each serving cell) (see FIG. 4). Here, shown is a case where candidate cells #0-1, #0-2, and #0-3 are associated with SpCell #0 (or a frequency domain corresponding to SpCell #0), candidate cell #1-1 is associated with SCell #1 (or a frequency domain corresponding to SCell #1), and candidate cells #2-1 and #2-2 are associated with SCell #2 (or a frequency domain corresponding to SCell #2). Information related to the association may be configured/indicated from the base station to the UE by RRC/MAC CE/DCI.

### Configuration Example 2

In configuration example 2, candidate cells are associated with/configured for a MAC entity/MCG/SCG (see FIG. 4). Here, shown is a case where candidate cells #3 to #8 are associated with a MAC entity/MCG/SCG. In this case, instead of a candidate cell(s) being associated with each serving cell, the candidate cells are configured for the MAC entity or cell group (for example, an MCG/SCG). Information related to the candidate cell(s) configured for each cell may be configured/indicated from the base station to the UE by RRC/MAC CE/DCI.

### Configuration Example 3

In configuration example 3, one or more candidate cell groups are configured (see FIG. 4). Each candidate cell group includes one or more candidate cells. Here, shown is a case where candidate cell group #1 including candidate cells #0 to #2, candidate cell group #2 including candidate cells #0 and #1, and candidate cell group #3 including candidate cell #0 are configured. At least one of information related to the candidate cell groups to be configured and information related to the candidate cell(s) included in each candidate cell group may be configured/indicated from the base station to the UE by RRC/MAC CE/DCI.

### {Serving Cell Switching}

In existing systems (for example, Rel. 17), L1 beam indication for a TCI state of an additional PCI (or an additional cell) (for example, indication by a TCI state field of DCI) is supported.

It is assumed, in Rel. 18 or later versions, that a new L1/L2 signal (for example, DCI/MAC CE) indicating switching of a serving cell (for example, serving cell switch) is supported. It may be assumed that, as the indication, at least one of implicit indication and explicit indication is supported. The implicit indication may mean that a certain CORESET is updated to a TCI state associated with an additional PCI by a MAC CE, for example. The explicit indication may mean that cell switching is directly indicated by DCI/MAC CE.

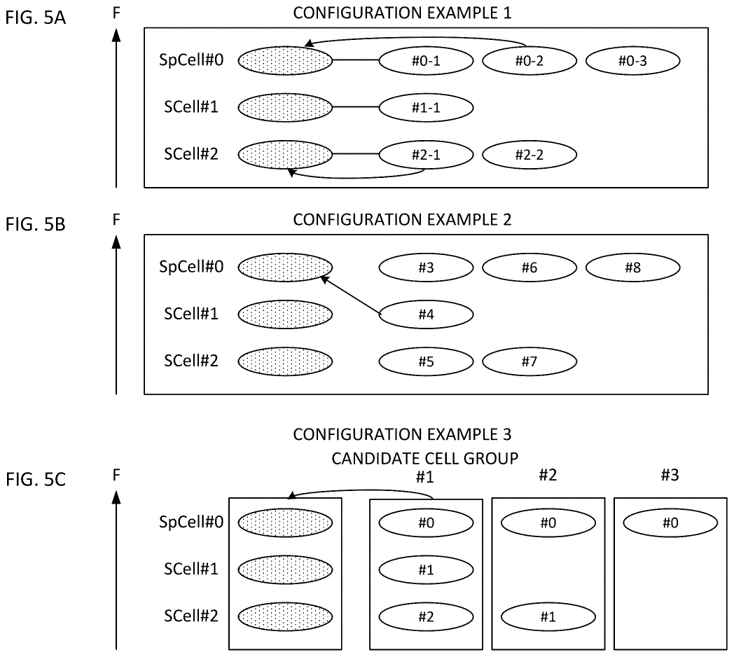

For example, in configuration example 1 of candidate cells, a certain candidate cell may be specified as a serving cell (or indicated for switching with a serving cell) via L1/L2 signaling. FIG. 5A shows a case where candidate cell #0-2 turns to be an SpCell of the MCG/SCG (SpCell #0 and candidate cell #0-2 are switched) by L1/L2 signaling. Also shown is a case where candidate cell #2-1 turns to be an SCell of an MCG/SCG (SCell #2 and candidate cell #2-1 are switched) by L1/L2 signaling.

Alternatively, in configuration example 2 of candidate cells, a certain candidate cell may be specified as a serving cell (or indicated for switching with a serving cell) via L1/L2 signaling. FIG. 5B shows a case where candidate cell #4 turns to be an SpCell of an MCG/SCG (SpCell #0 and candidate cell #4 are switched) by L1/L2 signaling.

Alternatively, in configuration example 3 of candidate cells, a certain candidate cell group (or one or more candidate cells included in the certain candidate cell group) may be changed/updated to a serving cell group via L1/L2 signaling. FIG. 5C shows a case where candidate cell group #1 (or candidate cells #0 to #2 included in candidate cell group #1) turns to be a serving cell group (or the serving cell group and candidate cell group #1 are switched) by L1/L2 signaling. Of the candidate cells (here, candidate cells #0 to #2) included in candidate cell group #1, the candidate cell associated with SpCell #0 or the candidate cell (here, candidate cell #0) configured for the same frequency domain as that of SpCell #0 may be configured as a new SpCell. Alternatively, the candidate cell to turn to be the SpCell may be indicated by L1/L2 signaling.

### (Timing Advance Group)

When a plurality of TRPs are used, there are some cases where the distance between a UE and each TRP is different. The plurality of TRPs may be included in the same cell (for example, a serving cell). Alternatively, among the plurality of TRPs, a certain TRP corresponds to the serving cell, while the other TRP(s) may correspond to a non-serving cell(s). In this case, it is also assumed that the distance between each TRP and the UE is different.

In existing systems, transmission timing of a UL (Uplink) channel and/or a UL signal (UL channel/signal) is adjusted by timing advance (TA). Reception timing of a UL channel/signal from a different user terminal (UE) is adjusted on the radio base station (also referred to as a TRP (Transmission and Reception Point), gNB (gNodeB), and the like)) side.

A UE may employ timing advance for each timing advance group (TAG) (multiple timing advances) configured in advance to perform timing control for UL transmission.

When the multiple timing advances is employed, timing advance groups (TAGs) classified according to transmission timing are supported. The UE may control UL transmission timing in each TAG by assuming that the same TA offset (or TA value) is used for each TAG. In other words, the TA offset may be configured independently for each TAG.

When the multiple timing advances are employed, the UE independently adjusting transmission timing for the cells belonging to each TAG enables matching at a radio base station in terms of timing of uplink signal reception from the UE even when a plurality of cells are used.

A TAG (for example, serving cells belonging to the same TAG) may be configured by a higher layer parameter. The same timing advance value may be applied to the serving cells belonging to the same TAG. A timing advance group including an SpCell of a MAC entity may be referred to as a primary timing advance group (PTAG), and a TAG other than the PTAG may be referred to as a secondary timing advance group (STAG).

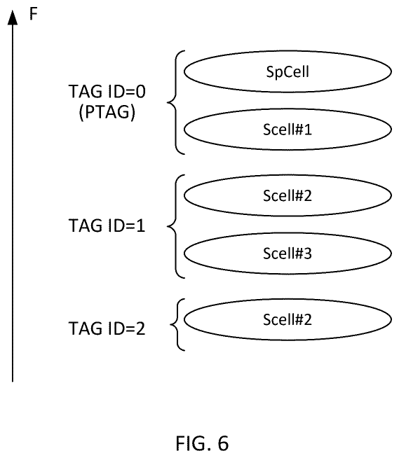

In existing systems (for example, Rel-16 NR), configuration of four TAGs at maximum (for example, MCG/SCG) is supported for each cell group (see FIG. 6). FIG. 6 shows a case where three TAGs are configured for a cell group including an SpCell and SCells #1 to #4. Here, shown is a case where the SpCell and SCell #1 belong to a first TAG (PTAG or TAG #0), SCell #2 and SCell #3 belong to a second TAG (TAG #1), and SCell #4 belongs to a third TAG (TAG #2).

A UE may be notified of a timing advance command (TA command) by using a MAC control element (for example, a MAC CE). The TA command is a command that indicates an uplink channel transmission timing value and is included in the MAC control element. The TA command is signaled from a radio base station to the UE on a MAC layer. The UE controls a certain timer (for example, a TA timer), based on reception of the TA command.

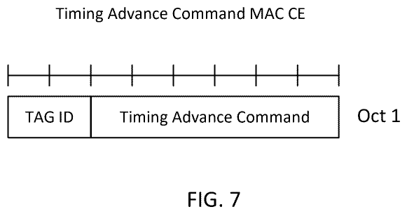

A MAC CE for TA command (TAC MAC CE) may have a structure including a field for timing advance group index (for example, TAG ID) and a field for TA command (see FIG. 7). For example, the TA command may be indicated by a response signal (for example, a RAR or a MAC RAR) for transmission of a random access channel (for example, a PRACH).

On the other hand, a case is assumed that, in future radio communication systems, a different TAG (or TAG-ID) is configured for each of one or more TRPs corresponding to a certain cell (or CC). For example, regarding multi-TRP operation using multi-DCI, it is assumed that two TAs (or TAGs) are supported for UL transmission.

Alternatively, a case is assumed that different TRPs corresponding to a certain cell share a common TAG. Alternatively, a case where the MAC CE for TA command is applied to only one TRP or a case where the MAC CE for TA command is applied to a plurality of TRPs is assumed.

Alternatively, a case is also assumed that TRPs corresponding to different cells use different TAGs/share a common TAG. For example, it is also assumed that UL transmission is controlled based on common/different timing advance for a serving cell (or a TRP of the serving cell) and a non-serving cell (or a TRP of the non-serving cell) in inter-cell mobility.

In this manner, it is also assumed that, in MIMO of Rel. 18 or later versions, two timing advances (TAs) for two TRPs are supported in multi-TRP operation using multi-DCI.

When the TAG is configured/controlled in a unit of a TRP, a time alignment timer (for example, timeAlignmentTimer) may be configured for each TRP. The time alignment timer may control time in which the MAC entity considers that the serving cell belonging to an associated TAG is uplink time aligned (for example, uplink time aligned). For example, in order to maintain (for example, maintenance) a UL time alignment, the time alignment timer may be configured by RRC.

The time alignment timer (for example, timeAlignmentTimer) may be maintained for the UL time alignment. In Rel. 17, the time alignment timer (for example, timeAlignmentTimer) corresponds to each TAG. When the UE has received a MAC CE for timing advance command (for example, a TAC MAC CE), the UE starts or restarts a time alignment timer related to each indicated timing advance group (for example, TAG).

When a MAC entity receives the TAC MAC CE, and a certain value (N_{TA}) is maintained for the indicated TAG, the MAC entity uses the timing advance command for the indicated TAG or starts or restarts the time alignment timer related to the indicated TAG. The certain value (N_{TA}) may be timing advance between DL and UL.

Operation when the time alignment timer expires may be defined separately for a PTAG and an STAG. Note that a timing advance group (TAG) including an SpCell of a MAC entity may be referred to as a primary timing advance group (PTAG), and a TAG other than the PTAG may be referred to as a secondary timing advance group (STAG).

For example, in Rel. 17, certain operation for PTAG is employed when a timing advance timer corresponding to a PTAG expires, and certain operation for STAG may be employed when a timing advance timer for STAG expires.

For example, when such a time alignment timer expires, the following operation (for example, the certain operation for PTAG/certain operation for STAG) may be performed.

### {Certain Operation for PTAG}

In a case where the time alignment timer is associated with a PTAG,
flush (discard) all the HARQ buffers of all serving cells.
notify RRC of release of a PUCCH, if configured, for all the serving cells.
notify RRC of release of an SRS, if configured.
clear all configured DL assignments and configured UL assignments.
clear a PUSCH resource for semi-persistent CSI reporting.
cause all running time alignment timers to expire.
maintain N_{TA} of all TAGs.

### {Certain Operation for STAG}

In a case where the time alignment timer is associated with an STAG, for all serving cells belonging to the TAG,
flush (discard) all HARQ buffers.
notify RRC of release of a PUCCH, if configured.
notify RRC of release of an SRS, if configured.
clear all configured DL assignments and UL assignments.
clear a PUSCH resource for semi-persistent CSI reporting.
maintain N_{TA} of the TAG.

### (TA Control in Unit of TRP/Panel)

As described above, when communication is performed using a plurality of transmission/reception points (for example, TRPs)/panels, it is also assumed to control timing advance (TA) for each TRP/for each panel.

In NR of Rel. 18 or later versions, it is considered that, regarding a RACH triggered by a PDCCH order and a RACH triggered by the UE, contention based random access (CBRA)/contention free random access (CFRA) is considered/determined in a unit of a TRP or in a unit of a TRP TA (TA of each TRP).

When application/configuration of timing advance is supported for each TRP (or for each TRP), the UE controls UL transmission (for example, RACH transmission or the like) in each TRP, based on timing advance corresponding to each TRP (or timing advance group to which each TRP belongs).

Information (for example, a TRP index/TRP ID) related to the TRP corresponding to each serving cell may be configured/indicated from the base station to the UE using RRC/MAC CE/downlink control information. The UE may receive related information related to timing advance corresponding to each TRP (for example, information related to a TA value/timing advance command/time alignment timer or the like) from the base station.

Each embodiment of the present disclosure may be applied/supported in at least one of an intra-cell multi-TRP (Intra-cell M-TRP) and an inter-cell multi-TRP (Inter-cell M-TRP).

In the intra-cell multi-TRP, a plurality of TRPs (or activated TCI states of a plurality of TRPs) may be associated with the same cell ID. The cell ID may be a physical cell ID (PCI).

In the inter-cell multi-TRP, a plurality of TRPs (or activated TCI states of a plurality of TRPs) may be associated with different cell IDs (for example, PCIs). For example, in the inter-cell multi-TRP, two TRPs may be interpreted as two TRPs respectively associated with two PCIs.

When application/configuration of timing advance is supported for each TRP (or in a unit of a TRP), each TRP may belong to a different TAG. A plurality of TRPs (for example, two TRPs) in the serving cell may respectively belong to two TAGs. The TAG may include a plurality of TRPs from a plurality of serving cells. All of the TRPs/serving cells in the TAG apply/maintain the same timing advance (TA)/same time alignment timer.

In the present disclosure, one or more sub-TAGs may be included in the TAG. For example, two TRPs in the serving cell may respectively belong to two sub-TAGs, and may belong to one TAG. The sub-TAG may include a plurality of TRPs from a plurality of serving cells. All of the TRPs/serving cells in the sub-TAG apply/maintain the same timing advance (TA)/same time alignment timer.

For example, the TA may be applied to each TRP (or indication in a unit of TRP TA may be performed). For example, at least one of the following options may be applied.

### {Option 1}

A different TAG-ID may be configured for each TRP, and a different MAC CE for TA command may be configured for each TRP. Each TAG may maintain the time alignment timer for UL time alignment.

### {Option 2}

Different TRPs may share the TAG. The MAC CE for TA command may be applied to only one TRP. The UE applies different TA to another TRP. For example, the UE may adjust the TA value for another TRP (for example, TRP #1) by a TA offset (TA_TRP_offset), based on TA for TRP #0 (TA_TRP #0).

In this case, only one time alignment timer may be present for the UL time alignment of a plurality of TRPs. This may mean that the UL time alignment of a plurality of TRPs is simultaneously maintained or lost.

### {Option 3}

A single TAG may be provided. A MAC CE for TA command may be applied to a plurality of serving TRPs for the UE.

### {Option 4}

A single TAG may be provided. A MAC CE for TA command received in the TRP/CW/PDSCH/DMRS port group may be applied to the same TRP/CW/PDSCH/DMRS port group of the TAG. Each TRP/CW/PDSCH/DMRS port group of the TAG maintains the time alignment timer for UL time alignment.

In this manner, it is also assumed that, in Rel. 18 or later versions, a plurality of timing advances are supported in the multi-TRP (for example, the multi-TRP using multi-DCI). For example, a plurality of (for example, two) timing advances may be supported for the multi-TRP (for example, two TRPs) using multi-DCI. Application of a plurality of timing advances for the multi-TRP may be supported in the intra-cell/inter-cell multi-DCI multi-TRP scenario (or the multi-TRP in MIMO, mobility using cells having different PCIs), or may be supported in a plurality of frequency ranges (for example, FR1 and FR2).

It is also assumed to support a case where, in the multi-DCI-based multi-TRP operation supporting a plurality of (for example, two) timing advances, a PDCCH (for example, a PDCCH order) transmitted from a certain TRP triggers a RACH procedure for the same TRP or a different TRP.

Incidentally, sufficient studies have not been carried out on how to perform reception of a PDSCH (or a MAC RAR) including a timing advance command in the multi-TRP operation (or inter-cell mobility) in which timing advance of each TRP (for example, per TRP TA) is supported as described above. For example, how the UE assumes QCL in reception of a PDSCH scheduled by a RA-RNTI in response to a random access procedure (for example, PRACH transmission) triggered by a PDCCH order poses a problem.

In existing systems (for example, Rel. 17 or earlier versions), when a response is made to a random access procedure triggered by a PDCCH order triggering a contention free random access procedure (for example, CFRA) of a specific cell (for example, an SpCell), the UE may assume that a DMRS of the PDCCH order and a DMRS of the PDSCH scheduled by a RA-RNTI are quasi-co-located (for example, quasi-co-located regarding the same SSB or CSI-RS).

In another case, the UE may assume that a DMRS port of a PDSCH scheduled by a RA-RNTI is quasi-co-located with a certain SSB or CSI-RS. The certain SSB or CSI-RS may be an SSB or a CSI-RS used for RACH association and transmission (for example, RACH association and transmission). Note that another case may be, for example, when the UE responds to a triggered RACH, responds to a random access procedure triggered by a PDCCH order triggering a contention based random access procedure (for example, CBRA), or responds to a random access procedure triggered by a PDCCH order for another cell (for example, an SCell).

On the other hand, in Rel. 18 or later versions, in order to acquire TA of each TRP (or TA of the serving cell and the non-serving cell), a RACH of each TRP (or each serving cell/non-serving cell) may be triggered. A case is also considered where, regarding a PDCCH order triggering a RACH procedure for the TRP (or the serving cell/non-serving cell), a PDCCH order and a PDSCH including RAR or a PDCCH order and a PDCCH for RAR are transmitted from different TRPs. The PDSCH including RAR (or a PDSCH used for transmission of RAR) may be interpreted as a PDSCH scheduled/scrambled by a RA-RNTI (or a PDCCH for RAR), or a PDSCH for RAR.

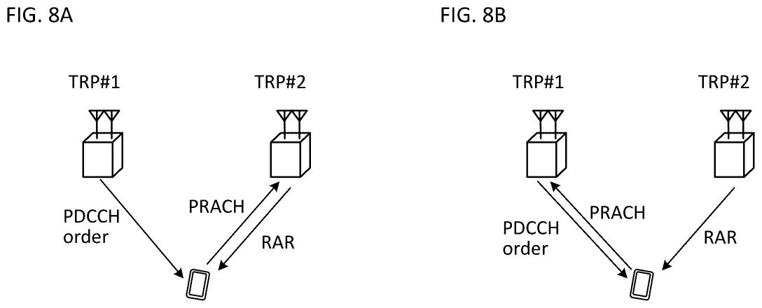

For example, it may be supported that a PDCCH order from TRP #1 triggers a RACH for TRP #2, and RAR is transmitted from TRP #2 (see FIG. 8A). In this case, a RACH for any TRP can be triggered via a PDCCH order from any TRP, and flexibility of the RACH procedure can be enhanced. Note that the PDCCH scheduling the PDSCH including RAR may be transmitted from TRP #2 transmitting the PDSCH, or may be transmitted from TRP #1.

As another example, it may be supported that a PDCCH order from TRP #1 may trigger a RACH for the TRP #1, and RAR is transmitted from TRP #2 (see FIG. 8B). The example may occur in the inter-cell multi-TRP (for example, inter-cell M-TRP) case when the UE cannot receive a type 1 CSS set from the TRP of the non-serving cell. Note that the PDCCH scheduling the PDSCH including RAR may be transmitted from TRP #2 transmitting the PDSCH, or may be transmitted from TRP #1.

In such a case, how to assume/configure QCL (for example, DMRS QCL) characteristics of the PDCCH order and the PDSCH including RAR poses a problem.

The inventors of the present invention focused on a case where a RACH is triggered for each TRP, studied a RACH procedure (for example, QCL (for example, DMRS QCL characteristics) in the RACH procedure) in such a case, and came up with the idea of one aspect of the present embodiment.

Alternatively, the inventors of the present invention focused on a case where a RACH for a non-serving cell is triggered, studied a RACH procedure (for example, QCL (for example, DMRS QCL characteristics) in the RACH procedure) in such a case, and came up with the idea of another aspect of the present embodiment.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, a TRP, a CORESET pool index (CORESETPoolIndex), a TRP ID, an ID related to a TRP, a TAG ID, a group of TCI states, a group of spatial relations, a group of QCL source RSs, a group of DL RSs, a group of path loss RSs, and a PCI (for an inter-cell multi-TRP) may be interchangeably interpreted.

In the present disclosure, being associated with a different TRP, being associated with a different CORESET pool index (CORESETPoolIndex), being associated with a different TRP ID, being associated with a different ID related to a TRP, being associated with a different TAG ID, being associated with a different group of TCI states, being associated with a different group of spatial relations, being associated with a different group of QCL source RSs, being associated with a different group of DL RSs, being associated with a different group of path loss RSs, and being associated with a different PCI (for an inter-cell multi-TRP) may be interchangeably interpreted.

Each embodiment of the present disclosure may be applied to at least one of an intra-cell multi-TRP and an inter-cell multi-TRP.

In the present disclosure, the intra-cell multi-TRP may mean that activated TCI states of a plurality of (for example, two) TRPs are associated with the same PCI.

In the present disclosure, the inter-cell multi-TRP may mean that activated TCI states of a plurality of (for example, two) TRPs are associated with different PCIs.

In the present disclosure, in a case of the inter-cell multi-TRP, a plurality of (for example, two) TRPs may mean a plurality of (for example, two) TRPs associated with a plurality of (for example, two) PCIs.

In the present disclosure, a non-serving cell, an additional cell, a candidate cell, and a target cell may be interchangeably interpreted.

The following embodiments may be applied when the RACH procedure of each TRP (or each serving cell/additional cell/non-serving cell) is configured/supported. Alternatively, the following embodiments may be applied when the timing advance/timing advance group of each TRP (or each serving cell/additional cell/non-serving cell) is configured/supported.

### Radio Communication Method

### First Embodiment

A first embodiment will describe QCL assumption in multi-DCI-based multi-TRP operation.

The first embodiment may be suitably applied when a plurality of (for example, two) timing advances (for example, TAs)/timing advance groups (for example, TAGs) are supported in the multi-TRP. Alternatively, the first embodiment may be suitably applied to transmission/reception using a plurality of TRPs included in the serving cell (or associated with the serving cell). As a matter of course, cases to which the first embodiment is applicable are not limited to these. In the first embodiment, application to single-DCI-based multi-TRP operation may be supported/permitted.

The UE may receive a first PDCCH (for example, a PDCCH order) used for a trigger of a random access procedure, a second PDCCH (for example, a PDCCH for RAR) scheduling a PDSCH for a response signal (for example, RAR) in the random access procedure, and a PDSCH for RAR. A case may be supported in which the first PDCCH and the PDSCH for RAR are transmitted from different cells or different TRPs. In such a case, the UE may determine quasi-co-location (QCL) assumption in reception of the PDSCH for RAR, based on at least one of a scenario applied to the random access procedure and configuration information of the TRPs.

For the multi-DCI-based multi-TRP operation including a plurality of (for example, two) TAs/TAGs, at least one of the following configuration 1-1 to configuration 1-3 (or two or more of configuration 1-1 to configuration 1-3 or a combination of all) may be configured.

### {Configuration 1-1}

For the UE, a plurality of (for example, two) CORESET pool indices for the serving cell are configured. The plurality of (for example, two) CORESET pool indices may be CORESET pool index=0 and CORESET pool index=1, for example.

### {Configuration 1-2}

For the UE, higher layer parameters related to the multi-DCI-based multi-TRP operation are configured.

### {Configuration 1-3}

For the UE, a plurality of (for example, two) TAGs are configured for the serving cell.

In a case of receiving a PDSCH scheduled by a RA-RNTI in response to a random access procedure (for example, PRACH transmission), the UE may apply at least one of the following option 1-1 to option 1-3.

The PDSCH scheduled (or scrambled) by a RA-RNTI may be interpreted as a PDSCH scheduled by a MSGB-RNTI, a PDSCH for RAR, a PDSCH including RAR, or a PDSCH scheduled by a PDCCH CRC-scrambled by a RA-RNTI. The PDSCH may be a PDSCH scheduled by a RA-RNTI in response to the random access procedure triggered by a PDCCH order triggering a contention free random access procedure for a specific cell (for example, an SpCell).

### {Option 1-1}

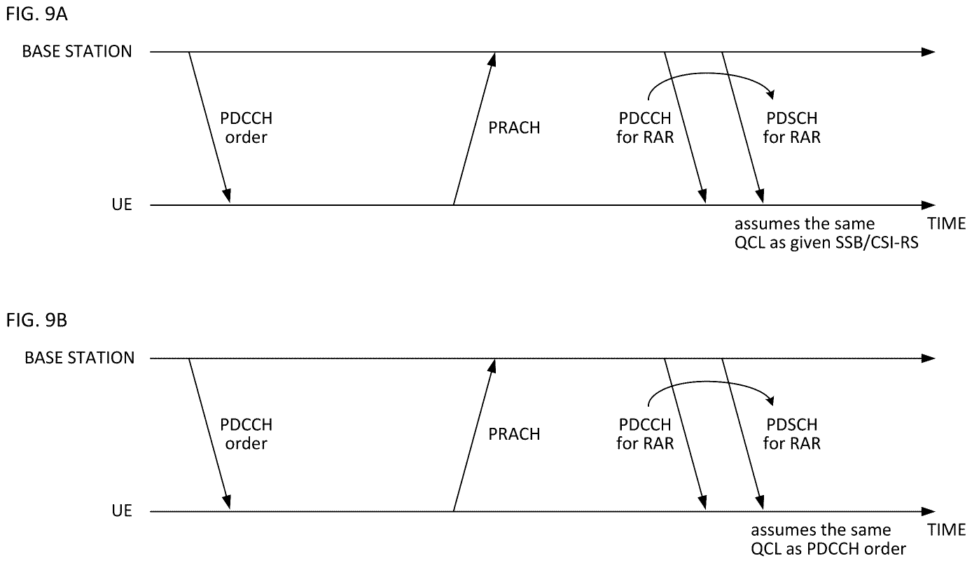

The UE may assume that a DMRS port of a PDSCH scheduled/scrambled by a RA-RNTI is quasi-co-located with a certain SS block or CSI-RS resource (see FIG. 9A). QCL assumption may be applied to Doppler shift, Doppler spread, average delay, delay spread, and spatial RX parameters.

The certain SS block or CSI-RS resource may be an SSB or a CSI-RS resource used for RACH association/transmission by the UE. The RACH association may be association with the SSB/CSI-RS resource corresponding to a PRACH/PRACH occasion transmitted by the UE, for example.

The certain SS block or CSI-RS resource may be the SS block or the CSI-RS resource associated with a specific PCI. The specific PCI may be indicated by a PDCCH order. Alternatively, the specific PCI may be a PCI associated with a triggering PDCCH (for example, a PDCCH order)/scheduling PDCCH. Alternatively, the specific PCI may be a PCI associated with a scheduled PDSCH.

### {Option 1-2}

The UE may assume that a DMRS port of a received PDCCH order and a DMRS port of a corresponding PDSCH scheduled by a RA-RNTI are quasi-co-located with the same SS block or CSI-RS resource (or quasi-co-located regarding the same SS block or CSI-RS resource) (see FIG. 9B). QCL assumption may be applied to Doppler shift (for example, Doppler shift), Doppler spread (for example, Doppler spread), average delay (for example, average delay), delay spread (for example, delay spread), and spatial RX parameters (for example, spatial RX parameters).

The SS block or the CSI-RS resource may be the SS block or the CSI-RS resource associated with a specific PCI. The specific PCI may be indicated by a PDCCH order. Alternatively, the specific PCI may be a PCI associated with a triggering PDCCH (for example, a PDCCH order)/scheduling PDCCH. Alternatively, the specific PCI may be a PCI associated with a scheduled PDSCH.

### {Option 1-3}

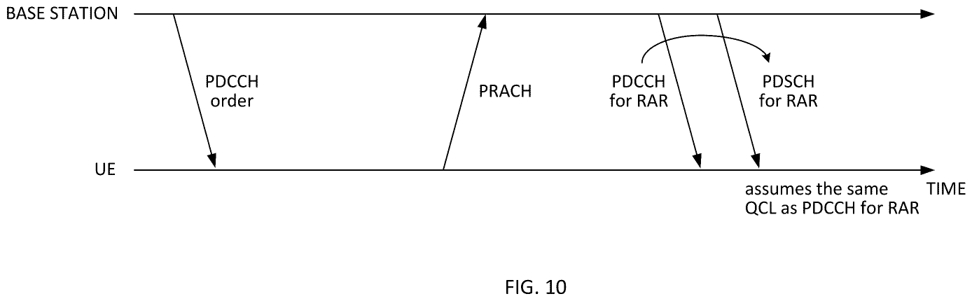

The UE may assume that QCL assumption of a PDSCH scheduled/scrambled by a RA-RNTI is the same QCL assumption as a scheduling PDCCH (or a PDCCH for RAR) scheduling the PDSCH (see FIG. 10). The scheduling PDCCH may be a PDCCH transmitted in response to a random access procedure (for example, PRACH transmission) and scrambled by a RA-RNTI.

Regarding QCL of the scheduling PDCCH, another signal/channel (for example, PDCCH order) may be determined based on a certain rule. Details of the certain rule may be that the scheduling PDCCH (or a DMRS of the scheduling PDCCH) and the PDCCH order (or a DMRS of the PDCCH order) have the same QCL characteristics, for example. Alternatively, details of the certain rule may be that the scheduling PDCCH (or a DMRS of the scheduling PDCCH) and a certain CORESET (or a DMRS corresponding to the certain CORESET) have the same QCL characteristics. The certain CORESET may be a CORESET associated with a certain CSS (for example, type 1-PDCCH CSS) set, for example.

### {QCL Assumption of Each Scenario}

For option 1-1 to option 1-3, different scenarios may be applied. In other words, application of at least two of option 1-1 to option 1-3 may be supported, based on the scenarios. In the present disclosure, the scenario may be interpreted as a condition, an application condition, or a configuration condition.

Different scenarios (or a plurality of scenarios) may be at least one of the following scenario #1-1 to scenario #1-9. A first scenario may include one or more scenarios, and a second scenario may include one or more other scenarios.

### <<Scenario #1-1>>

Scenario #1-1 may be a case where the RACH procedure is triggered by a PDCCH order triggering a contention free random access (for example, CFRA).

### <<Scenario #1-2>>

Scenario #1-2 may be a case where the RACH procedure is triggered by a PDCCH order triggering a contention based random access (for example, CBRA).

### <<Scenario #1-3>>

Scenario #1-3 may be a case where the RACH procedure is triggered by the UE.

### <<Scenario #1-4>>

Scenario #1-4 may be a case where the RACH procedure is for an SpCell.

### <<Scenario #1-5>>

Scenario #1-5 may be a case where the RACH procedure is for an SCell.

### <<Scenario #1-6>>

Scenario #1-6 may be a case where the multi-TRP operation is an intra-cell multi-TRP (for example, an intra-cell M-TRP). The intra-cell multi-TRP may mean a case where activated TCI states of a plurality of (for example, two) TRPs are associated with the same PCI.

### <<Scenario #1-7>>

Scenario #1-7 may be a case where the multi-TRP operation is an inter-cell multi-TRP (for example, an inter-cell M-TRP). The intra-cell multi-TRP may mean a case where activated TCI states of a plurality of (for example, two) TRPs are associated with different PCIs.

### <<Scenario #1-8>>

Scenario #1-8 may be a case where a PDSCH scheduled by a RA-RNTI (or a PDCCH scrambled by a RA-RNTI) and a PDCCH order are associated with the same TRP. For example, it may be a case where the PDSCH and the PDCCH order are transmitted from the same TRP. The same TRP may be interpreted as the same CORESET pool index, or the same PCI for the inter-cell multi-TRP case.

For example, it corresponds to a case where both of the PDSCH scheduled by a RA-RNTI and the PDCCH order are associated with the same CORESET pool index (for example, CORESET pool index=0 or CORESET pool index=1).

Alternatively, it corresponds to a case where both of the PDSCH scheduled by a RA-RNTI and the PDCCH order are associated with the PCI of the serving cell, or are associated with the non-serving cell/additional PCI.

### <<Scenario #1-9>>

Scenario #1-9 may be a case where a PDSCH scheduled by a RA-RNTI (or a PDCCH scrambled by a RA-RNTI) and a PDCCH order are associated with different TRPs. For example, it may be a case where the PDSCH and the PDCCH order are transmitted from different TRPs. Different TRPs may be interpreted as different CORESET pool indices, or different PCIs for the inter-cell multi-TRP case.

For example, it corresponds to a case where the PDSCH scheduled by a RA-RNTI is associated with CORESET pool index=0, and the PDCCH order is associated with CORESET pool index=1.

Alternatively, it corresponds to a case where the PDSCH scheduled by a RA-RNTI is associated with CORESET pool index=1, and the PDCCH order is associated with CORESET pool index=0.

Alternatively, it corresponds to a case where the PDSCH scheduled by a RA-RNTI is associated with the PCI of the serving cell, and the PDCCH order is associated with the non-serving cell/additional PCI.

Alternatively, it corresponds to a case where the PDSCH scheduled by a RA-RNTI is associated with the non-serving cell/additional PCI, and the PDCCH order is associated with the PCI of the serving cell.

### {Relationship Between Options and Scenarios}

For a RACH triggered by a PDCCH order (for example, scenario #1-1/scenario #1-2), option 1-2 may be applied.

For a RACH triggered by a PDCCH order for an SpCell (for example, scenario #1-4), option 1-2 may be applied.

For a RACH triggered by a PDCCH order for an SCell (for example, scenario #1-5), option 1-1/option 1-3 may be applied.

When a PDSCH scheduled by a RA-RNTI and a PDCCH order are associated with the same TRP/CORESET pool index/PCI (for example, scenario #1-8), option 1-2 may be applied.

When a PDSCH scheduled by a RA-RNTI and a PDCCH order are associated with different TRPs/CORESET pool indices/PCIs (for example, scenario #1-9), option 1-1/option 1-3 may be applied.

When a RACH is triggered by a PDCCH order in the intra-cell multi-TRP (for example, the intra-cell M-TRP) (for example, scenario #1-6), option 1-2 may be applied.

When a RACH is triggered by a PDCCH order in the inter-cell multi-TRP (for example, the inter-cell M-TRP) (for example, scenario #1-7), option 1-1/option 1-3 may be applied.

For a RACH triggered by the UE (for example, scenario #1-3), option 1-1/option 1-3 may be applied.

Note that the correspondence between the scenarios and the options to be applied to is an example, and the present embodiment may be applied without being limited to the correspondence described above.

### {Variations}

A part of the scenarios may be supported, with not all of scenario #1-1 to scenario #1-9 being supported. For example, the scenarios supported by each UE may be determined based on a UE capability. In this case, the UE need not assume a part of the scenarios (for example, the scenarios not supported by the UE).

Which QCL assumption (for example, option 1-1/1-2/1-3) is applied to which scenario may be defined in a specification, or may be configured from the base station to the UE by a higher layer parameter/DCI or the like.

Note that, although the first embodiment shows three cases of first QCL assumption (for example, option 1-1), second QCL assumption (for example, option 1-2), and third QCL assumption (for example, option 1-3) as the QCL assumptions, applicable/supportable QCL assumptions are not limited to these. For example, other QCL assumption (for example, fourth QCL assumption) may be applied/supported. As an example, QCL (or TCI states) of a PDSCH for RAR may be indicated/notified by DCI (for example, a certain field in DCI) transmitted using a scheduling PDCCH (or a PDCCH for RAR).

Although the first embodiment shows examples of scenario #1-1 to scenario #1-9, applicable scenarios are not limited to these. Another scenario may be additionally applied/supported, or two or more scenarios of scenario #1-1 to scenario #1-9 may be aggregated into one scenario.

The first embodiment may be applied to a specific cell (for example, an SpCell), or may be applied to another cell (for example, an SCell).

According to the first embodiment, even when the multi-TRP (or application of the TA/TAG for each TRP) is supported, the QCL assumption to be applied in the RACH procedure can be appropriately controlled.

### Second Embodiment

A second embodiment will describe QCL assumption in inter-cell mobility.

The second embodiment may be suitably applied when a plurality of (for example, two) timing advances (for example, TAs)/timing advance groups (for example, TAGs) are supported in inter-cell mobility. Alternatively, the second embodiment may be suitably applied to transmission/reception/mobility using the serving cell (or one or more TRPs corresponding to the serving cell) and the non-serving cell (or one or more TRPs corresponding to the non-serving cell). As a matter of course, cases to which the second embodiment is applicable are not limited to these.

The UE may receive a first PDCCH (for example, a PDCCH order) used for a trigger of a random access procedure for the non-serving cell, a second PDCCH (for example, a PDCCH for RAR) scheduling a PDSCH for a response signal (for example, RAR) in the random access procedure, and a PDSCH for RAR. A case may be supported in which the first PDCCH and the PDSCH for RAR are transmitted from different cells (for example, the serving cell/non-serving cell). In such a case, the UE may determine quasi-co-location (QCL) assumption in reception of the PDSCH for RAR, based on at least one of a scenario applied to the random access procedure and the cells associated with the PDCCH order and the PDSCH for RAR.

In the present disclosure, the non-serving cell may be interpreted as a candidate cell, an additional cell, or a target cell.

For operation of mobility among a plurality of cells, in a case of receiving a PDSCH scheduled by a RA-RNTI in response to a random access procedure (for example, PRACH transmission) for the non-serving cell, the UE may apply at least one of the following option 2-1 to option 2-3.

The PDSCH scheduled (or scrambled) by a RA-RNTI may be interpreted as a PDSCH scheduled by a MSGB-RNTI, a PDSCH for RAR, a PDSCH including RAR, or a PDSCH scheduled by a PDCCH CRC-scrambled by a RA-RNTI.

### {Option 2-1}

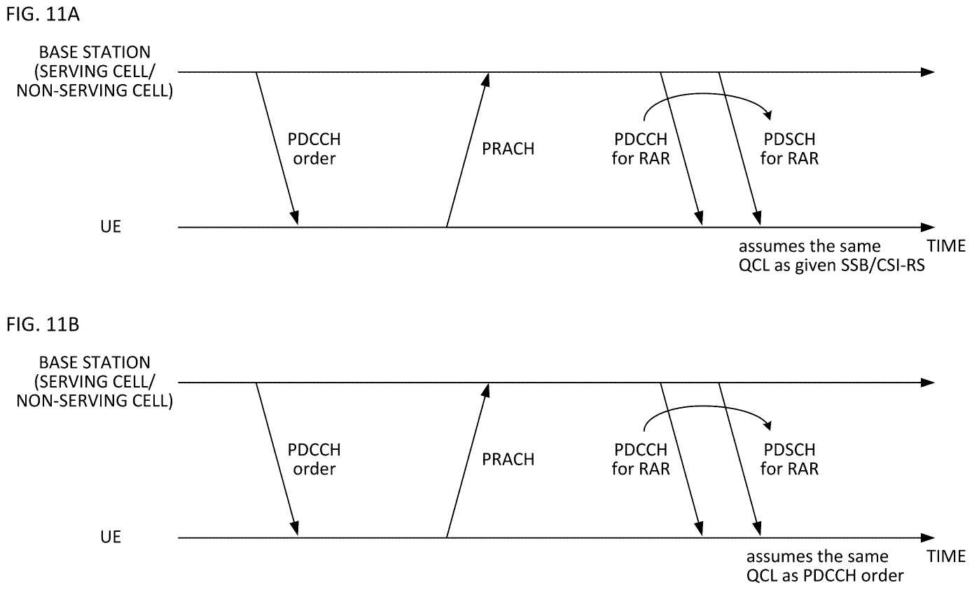

The UE may assume that a DMRS port of a PDSCH scheduled/scrambled by a RA-RNTI is quasi-co-located with a certain SS block or CSI-RS resource (see FIG. 11A). QCL assumption may be applied to Doppler shift (for example, Doppler shift), Doppler spread (for example, Doppler spread), average delay (for example, average delay), delay spread (for example, delay spread), and spatial RX parameters (for example, spatial RX parameters).

The certain SS block or CSI-RS resource may be an SSB or a CSI-RS resource used for RACH association/transmission by the UE. The RACH association may be association with the SSB/CSI-RS resource corresponding to a RACH/RACH occasion transmitted by the UE, for example.

For inter-cell mobility, SSB #1 of cell #1 (or PCI #1) and SSB #1 of cell #2 (or PCI #2) may be different. The certain SS block or CSI-RS resource may be the SS block or the CSI-RS resource associated with a specific PCI. The specific PCI may be indicated by a cell switch command. Alternatively, the specific PCI may be indicated by a PDCCH order. Alternatively, the specific PCI may be a PCI associated with a triggering PDCCH (for example, a PDCCH order)/scheduling PDCCH. Alternatively, the specific PCI may be a PCI associated with a scheduled PDSCH.

### {Option 2-2}

The UE may assume that a DMRS port of a received PDCCH order and a DMRS port of a corresponding PDSCH scheduled by a RA-RNTI are quasi-co-located with the same SS block or CSI-RS resource (or quasi-co-located regarding the same SS block or CSI-RS resource) (see FIG. 11B). QCL assumption may be applied to Doppler shift (for example, Doppler shift), Doppler spread (for example, Doppler spread), average delay (for example, average delay), delay spread (for example, delay spread), and spatial RX parameters (for example, spatial RX parameters).

The SS block or the CSI-RS resource may be the SS block or the CSI-RS resource associated with a specific PCI. The specific PCI may be indicated by a cell switch command (for example, cell switch command). Alternatively, the specific PCI may be indicated by a PDCCH order. Alternatively, the specific PCI may be a PCI associated with a triggering PDCCH (for example, a PDCCH order)/scheduling PDCCH. Alternatively, the specific PCI may be a PCI associated with a scheduled PDSCH.

### {Option 2-3}

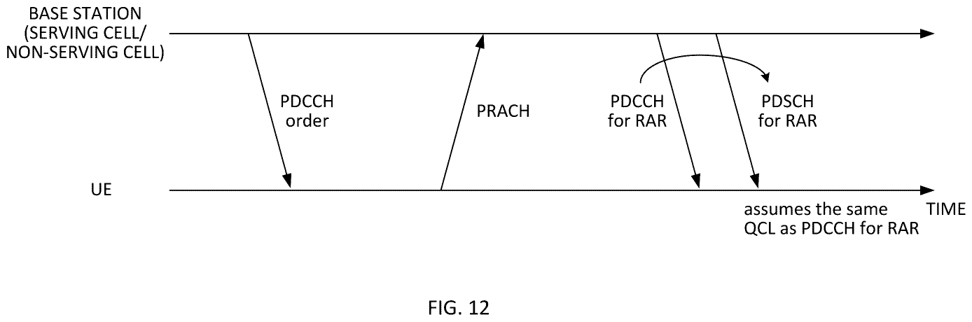

The UE may assume that QCL assumption (for example, QCL assumption) of a PDSCH scheduled/scrambled by a RA-RNTI is the same QCL assumption as a scheduling PDCCH scheduling the PDSCH (see FIG. 12). The scheduling PDCCH may be a PDCCH transmitted in response to a random access procedure (for example, PRACH transmission) and scrambled by a RA-RNTI.

Regarding QCL of the scheduling PDCCH, another signal/channel (for example, PDCCH order) may be determined based on a certain rule. Details of the certain rule may be that the scheduling PDCCH (or a DMRS of the scheduling PDCCH) and the PDCCH order (or a DMRS of the PDCCH order) have the same QCL characteristics, for example. Alternatively, details of the certain rule may be that the scheduling PDCCH (or a DMRS of the scheduling PDCCH) and a certain CORESET (or a DMRS corresponding to the certain CORESET) have the same QCL characteristics.

The certain CORESET may be a CORESET associated with a certain CSS (for example, type 1-PDCCH CSS) set, for example. The certain CSS (for example, type 1-PDCCH CSS) set may be a type 1-PDCCH CSS set from the non-serving cell in which a RACH is triggered, for example. In this case, the type 1-PDCCH CSS set may be separately provided/configured for each non-serving cell. Alternatively, the certain CSS (for example, type 1-PDCCH CSS) set may be a type 1-PDCCH CSS set from the serving cell. This case may be applied when the non-serving cell corresponds to the same frequency as that of the serving cell.

### {QCL Assumption of Each Scenario}

For option 2-1 to option 2-3, different scenarios may be applied. In other words, application of at least two of option 2-1 to option 2-3 may be supported, based on the scenarios. In the present disclosure, the scenario may be interpreted as a condition, an application condition, or a configuration condition.

Different scenarios (or a plurality of scenarios) may be at least one of the following scenario #2-1 to scenario #2-6. A first scenario may include one or more scenarios, and a second scenario may include one or more other scenarios.

### <<Scenario #2-1>>

Scenario #2-1 may be a case where the RACH procedure is triggered by a PDCCH order triggering a contention free random access (for example, CFRA).

### <<Scenario #2-2>>

Scenario #2-2 may be a case where the RACH procedure is triggered by a PDCCH order triggering a contention based random access (for example, CBRA).

### <<Scenario #2-3>>

Scenario #2-3 may be a case where the RACH procedure is triggered by the UE.

### <<Scenario #2-4>>

Scenario #2-4 may be a case where both of a PDSCH scheduled by a RA-RNTI (or a PDCCH scrambled by a RA-RNTI) and a PDCCH order are associated with the serving cell (or the PCI of the serving cell). Alternatively, it may be a case where both of a PDSCH scheduled by a RA-RNTI (or a PDCCH scrambled by a RA-RNTI) and a PDCCH order are associated with the non-serving cell/additional cell (or the PCI of the non-serving cell/PCI of the additional cell).

### <<Scenario #2-5>>

Scenario #2-5 may be a case where a PDSCH scheduled by a RA-RNTI (or a PDCCH scrambled by a RA-RNTI) is associated with the serving cell (or the PCI of the serving cell), and a PDCCH order is associated with the non-serving cell/additional cell (or the PCI of the non-serving cell/PCI of the additional cell).

### <<Scenario #2-6>>

Scenario #2-6 may be a case where a PDSCH scheduled by a RA-RNTI (or a PDCCH scrambled by a RA-RNTI) is associated with the non-serving cell/additional cell (or the PCI of the non-serving cell/PCI of the additional cell), and a PDCCH order is associated with the serving cell (or the PCI of the serving cell).

### {Relationship Between Options and Scenarios}

For a RACH triggered by a PDCCH order (for example, scenario #2-1/scenario #2-2), option 2-2 may be applied.

When a PDSCH scheduled by a RA-RNTI and a PDCCH order are associated with the same cell/PCI (for example, scenario #2-4), option 2-2 may be applied.

When a PDSCH scheduled by a RA-RNTI and a PDCCH order are associated with different cells/PCIs (for example, scenario #2-5/scenario #2-6), option 2-1/option #2-3 may be applied.

For a RACH triggered by the UE (for example, scenario #2-3), option 2-1/option 2-3 may be applied.

Note that the correspondence between the scenarios and the options to be applied to is an example, and the present embodiment may be applied without being limited to the correspondence described above.

### {Variations}

A part of the scenarios may be supported, with not all of scenario #2-1 to scenario #2-6 being supported. For example, the scenarios supported by each UE may be determined based on a UE capability. In this case, the UE need not assume a part of the scenarios (for example, the scenarios not supported by the UE).

Which QCL assumption (for example, option 2-1/2-2/2-3) is applied to which scenario may be defined in a specification, or may be configured from the base station to the UE by a higher layer parameter/DCI or the like.

Note that, although the second embodiment shows three cases of first QCL assumption (for example, option 2-1), second QCL assumption (for example, option 2-2), and third QCL assumption (for example, option 2-3) as the QCL assumptions, applicable/supportable QCL assumptions are not limited to these. For example, other QCL assumption (for example, fourth QCL assumption) may be applied/supported. As an example, QCL (or TCI states) of a PDSCH for RAR may be indicated/notified by DCI (for example, a certain field in DCI) transmitted using a scheduling PDCCH (or a PDCCH for RAR).

Although the second embodiment shows examples of scenario #2-1 to scenario #2-6, applicable scenarios are not limited to these. Another scenario may be additionally applied/supported, or two or more scenarios of scenario #2-1 to scenario #2-6 may be aggregated into one scenario.

The second embodiment may be applied to a specific cell (for example, an SpCell), or may be applied to another cell (for example, an SCell).

According to the second embodiment, even when inter-cell mobility is supported, the QCL assumption to be applied in the RACH procedure can be appropriately controlled.

### <Supplements>

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

{Notification of Information from UE}

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
support two TAs for a multi-TRP,
support two TAs for an intra-cell multi-TRP (for example, an intra-cell M-TRP),
support two TAs for an inter-cell multi-TRP (for example, an inter-cell M-TRP),
support L1/L2 inter-cell mobility.

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling.

In a case where the UE does not support at least one of the specific UE capability or is not configured with the specific information, the UE may apply, for example, Rel-15/16 operation.

### (Supplementary Note)

Regarding one embodiment of the present disclosure, the following supplementary notes of the invention will be given.

### {Supplementary Note 1-1}

A terminal including a receiving section that receives a first downlink control channel used for a trigger of a random access procedure, a second downlink control channel for scheduling a downlink shared channel for a response signal in the random access procedure, and the downlink shared channel, and a control section that determines, when a case is supported in which the first downlink control channel and the downlink shared channel are transmitted from different cells or different transmission/reception points, quasi-co-location (QCL) assumption in reception of the downlink shared channel, based on at least one of a scenario applied to the random access procedure and configuration information of the transmission/reception points.

### {Supplementary Note 1-2}

The terminal according to supplementary note 1-1, wherein when the first downlink control channel and the downlink shared channel are associated with a same transmission/reception point, a same control resource set pool index, or a same physical cell ID, the control section determines that a demodulation reference signal of the first downlink control channel and the demodulation reference signal of the downlink shared channel are quasi-co-located.

### {Supplementary Note 1-3}

The terminal according to supplementary note 1-1 or 1-2, wherein when the first downlink control channel and the downlink shared channel are associated with different transmission/reception points, different control resource set pool indices, or different physical cell IDs, the control section determines that a demodulation reference signal of the downlink shared channel is quasi-co-located with a synchronization signal block or a channel state information reference signal corresponding to the random access procedure.

### {Supplementary Note 1-4}

The terminal according to any one of supplementary notes 1-1 to 1-3, wherein timing advance is separately applied to each of the different cells or the different transmission/reception points.

### {Supplementary Note 2-1}

A terminal including: a receiving section that receives a first downlink control channel used for a trigger of a random access procedure for a non-serving cell, a second downlink control channel for scheduling a downlink shared channel for a response signal in the random access procedure, and the downlink shared channel; and when a case is supported in which the first downlink control channel and the downlink shared channel are transmitted from different cells, a control section that determines quasi-co-location (QCL) assumption in reception of the downlink shared channel, based on at least one of a scenario applied to the random access procedure and cells associated with the first downlink control channel and the downlink shared channel.

### {Supplementary Note 2-2}

The terminal according to supplementary note 2-1, wherein when the first downlink control channel and the downlink shared channel are associated with a same physical cell ID, the control section determines that a demodulation reference signal of the first downlink control channel and the demodulation reference signal of the downlink shared channel are quasi-co-located.

### {Supplementary Note 2-3}

The terminal according to supplementary note 2-1 or 2-2, wherein when the first downlink control channel and the downlink shared channel are associated with a same physical cell ID, the control section determines that a demodulation reference signal of the downlink shared channel is quasi-co-located with a synchronization signal block or a channel state information reference signal corresponding to the random access procedure.

### {Supplementary Note 2-4}

The terminal according to any one of supplementary notes 2-1 to 2-3, wherein timing advance is separately applied to each of the different cells.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

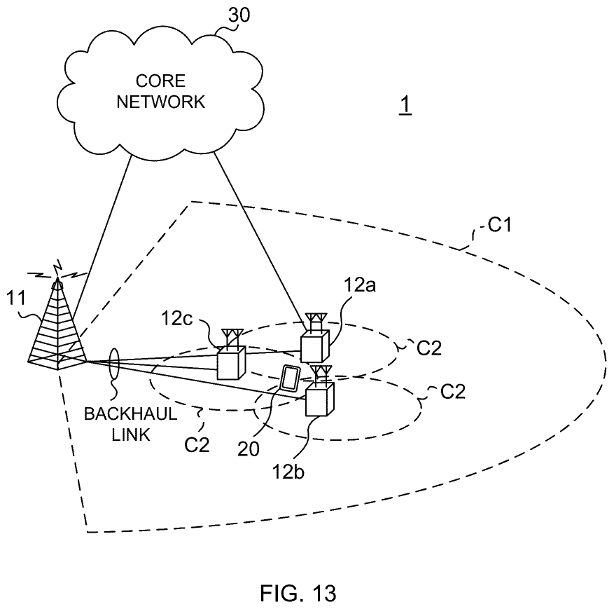

FIG. 13 is a diagram to show an example of a schematic structure of the radio communication system according to one embodiment. The radio communication system 1 (which may be simply referred to as system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (LAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF), such as a User Plane Function (UPF), an Access and Mobility management Function (AMF), a Session Management Function (SMF), Unified Data Management (UDM), an Application Function (AF), a Data Network (DN), a Location Management Function (LMF), and operation, administration, and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

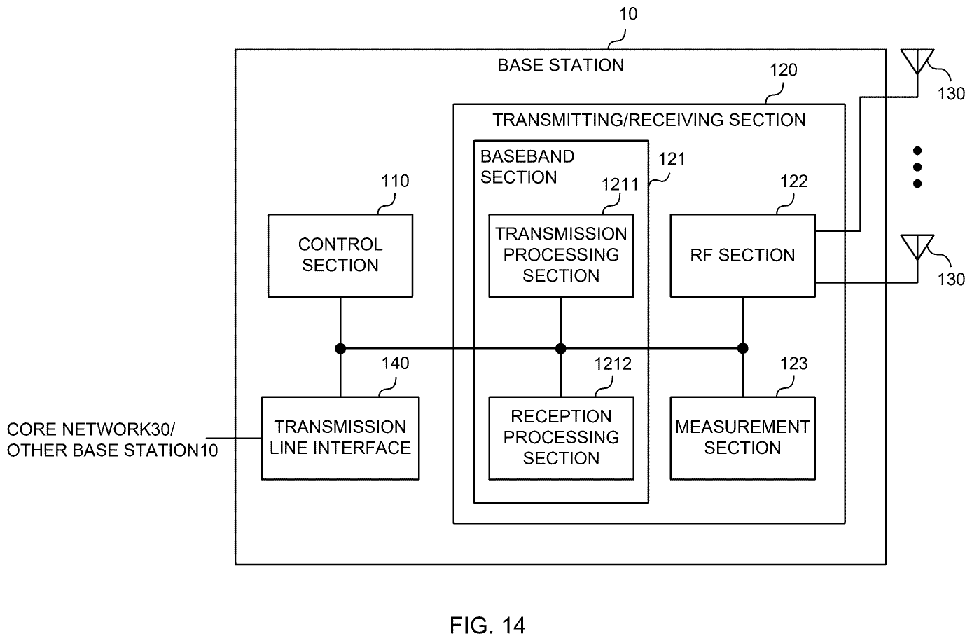

FIG. 14 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 (for example, a network node providing NF) or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a first downlink control channel used for a trigger of a random access procedure, a second downlink control channel for scheduling a downlink shared channel for a response signal in the random access procedure, and the downlink shared channel. When a case is supported in which the first downlink control channel and the downlink shared channel are transmitted from different cells or different transmission/reception points, the control section 110 may control quasi-co-location (QCL) of the downlink shared channel, based on at least one of a scenario applied to the random access procedure and configuration information of the transmission/reception points.

The transmitting/receiving section 120 may transmit a first downlink control channel used for a trigger of a random access procedure for a non-serving cell, a second downlink control channel for scheduling a downlink shared channel for a response signal in the random access procedure, and the downlink shared channel. When a case is supported in which the first downlink control channel and the downlink shared channel are transmitted from different cells, the control section 110 may control quasi-co-location (QCL) of the downlink shared channel, based on at least one of a scenario applied to the random access procedure and cells associated with the first downlink control channel and the downlink shared channel.

### (User Terminal)

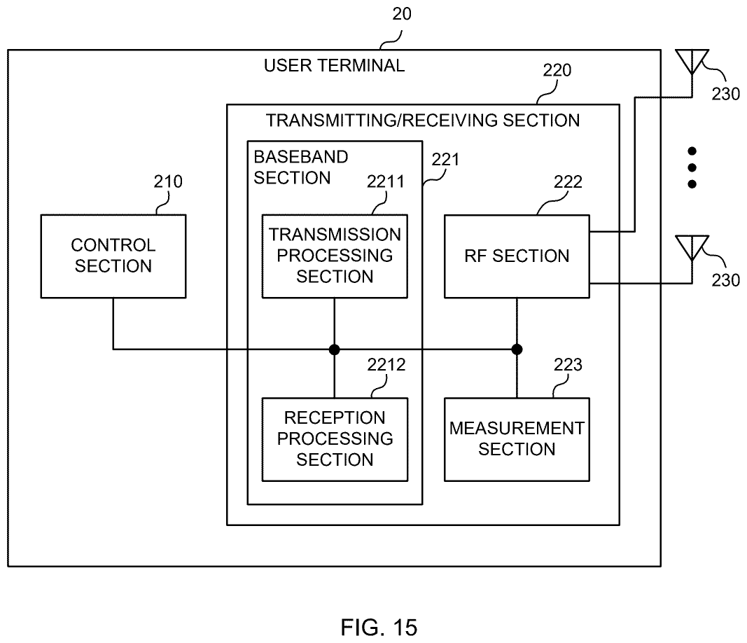

FIG. 15 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a first downlink control channel used for a trigger of a random access procedure, a second downlink control channel for scheduling a downlink shared channel for a response signal in the random access procedure, and the downlink shared channel. When a case is supported in which the first downlink control channel and the downlink shared channel are transmitted from different cells or different transmission/reception points, the control section 210 may determine quasi-co-location (QCL) assumption in reception of the downlink shared channel, based on at least one of a scenario applied to the random access procedure and configuration information of the transmission/reception points.

When the first downlink control channel and the downlink shared channel are associated with a same transmission/reception point, a same control resource set pool index, or a same physical cell ID, the control section 210 may determine that a demodulation reference signal of the first downlink control channel and the demodulation reference signal of the downlink shared channel are quasi-co-located. When the first downlink control channel and the downlink shared channel are associated with different transmission/reception points, different control resource set pool indices, or different physical cell IDs, the control section 210 may determine that a demodulation reference signal of the downlink shared channel is quasi-co-located with a synchronization signal block or a channel state information reference signal corresponding to the random access procedure. Timing advance may be separately applied to each of the different cells or the different transmission/reception points.

The transmitting/receiving section 220 may receive a first downlink control channel used for a trigger of a random access procedure for a non-serving cell, a second downlink control channel for scheduling a downlink shared channel for a response signal in the random access procedure, and the downlink shared channel. When a case is supported in which the first downlink control channel and the downlink shared channel are transmitted from different cells, the control section 210 may determine quasi-co-location (QCL) assumption in reception of the downlink shared channel, based on at least one of a scenario applied to the random access procedure and cells associated with the first downlink control channel and the downlink shared channel.

When the first downlink control channel and the downlink shared channel are associated with a same physical cell ID, the control section 210 may determine that a demodulation reference signal of the first downlink control channel and the demodulation reference signal of the downlink shared channel are quasi-co-located. When the first downlink control channel and the downlink shared channel are associated with a same physical cell ID, the control section 210 may determine that a demodulation reference signal of the downlink shared channel is quasi-co-located with a synchronization signal block or a channel state information reference signal corresponding to the random access procedure. Timing advance may be separately applied to each of the different cells (for example, a serving cell and the non-serving cell).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

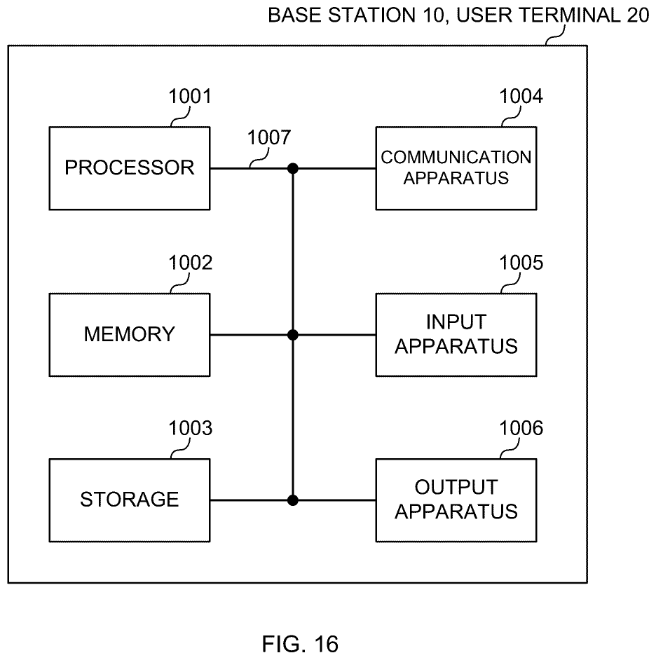

For example, a base station, a user terminal, and so on according to one embodiment of the present disclosure may function as a computer that executes the processes of the radio communication method of the present disclosure. FIG. 16 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

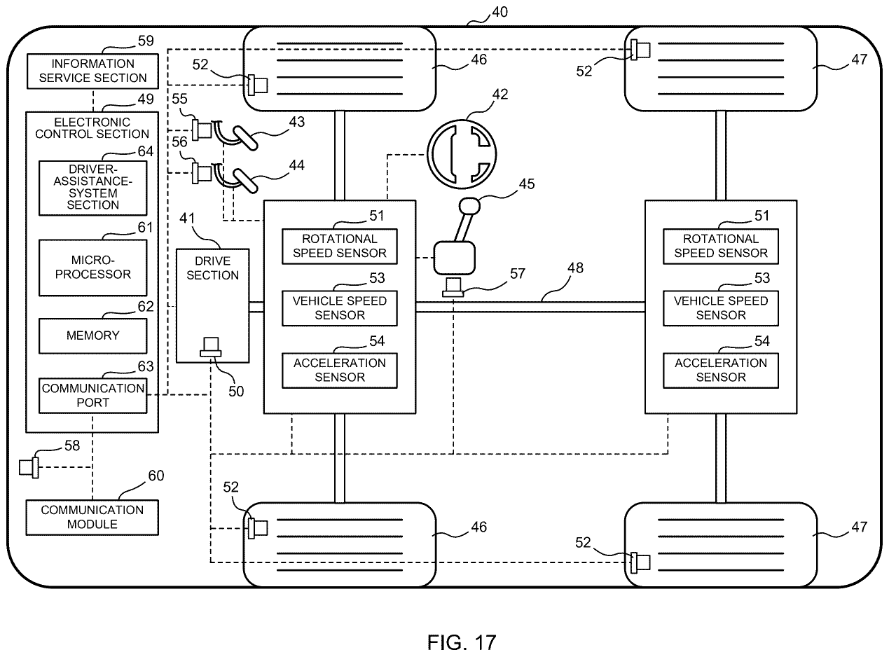

FIG. 17 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions(determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions(determinations)” about receiving (for example, receiving information), transmitting (for example, transmitting information), input, output, accessing (for example, accessing data in a memory), and so on.

In addition, “deciding (determining)” as used herein may be interpreted to mean making “decisions(determinations)” about resolving, selecting, choosing, establishing, comparing, and so on. In other words, “deciding (determining)” may be interpreted to mean making “decisions (determinations)” about some action.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1. A terminal comprising:
a receiving section that receives a first downlink control channel used for a trigger of a random access procedure, a second downlink control channel for scheduling a downlink shared channel for a response signal in the random access procedure, and the downlink shared channel; and
a control section that determines, when a case is supported in which the first downlink control channel and the downlink shared channel are transmitted from different cells or different transmission/reception points, quasi-co-location (QCL) assumption in reception of the downlink shared channel, based on at least one of a scenario applied to the random access procedure and configuration information of the transmission/reception points.

2. The terminal according to claim 1, wherein
when the first downlink control channel and the downlink shared channel are associated with a same transmission/reception point, a same control resource set pool index, or a same physical cell ID, the control section determines that a demodulation reference signal of the first downlink control channel and the demodulation reference signal of the downlink shared channel are quasi-co-located.

3. The terminal according to claim 1, wherein
when the first downlink control channel and the downlink shared channel are associated with different transmission/reception points, different control resource set pool indices, or different physical cell IDs, the control section determines that a demodulation reference signal of the downlink shared channel is quasi-co-located with a synchronization signal block or a channel state information reference signal corresponding to the random access procedure.

4. The terminal according to claim 1, wherein
timing advance is separately applied to each of the different cells or the different transmission/reception points.

5. A radio communication method for a terminal, the radio communication method comprising:
receiving a first downlink control channel used for a trigger of a random access procedure, a second downlink control channel for scheduling a downlink shared channel for a response signal in the random access procedure, and the downlink shared channel; and
when a case is supported in which the first downlink control channel and the downlink shared channel are transmitted from different cells or different transmission/reception points, determining quasi-co-location (QCL) assumption in reception of the downlink shared channel, based on at least one of a scenario applied to the random access procedure and configuration information of the transmission/reception points.

6. A base station comprising:
a transmitting section that transmits a first downlink control channel used for a trigger of a random access procedure, a second downlink control channel for scheduling a downlink shared channel for a response signal in the random access procedure, and the downlink shared channel; and
a control section that controls, when a case is supported in which the first downlink control channel and the downlink shared channel are transmitted from different cells or different transmission/reception points, quasi-co-location (QCL) of the downlink shared channel, based on at least one of a scenario applied to the random access procedure and configuration information of the transmission/reception points.
